(19) United States
(12) Patent Application Publication
(10) Pub. No.: US 2020/0020924 A1
(43) Pub. Date: Jan. 16, 2020

(54) SECONDARY BATTERY

(71) Applicant: Panasonic Intellectual Property Management Co., Ltd., Osaka (JP)

(72) Inventors: Hideharu Takezawa, Nara (JP); Daisuke Furusawa, Osaka (JP); Yuji Oura, Osaka (JP); Takahiro Takahashi, Osaka (JP); Takahito Nakayama, Osaka (JP); Tomoki Shiozaki, Osaka (JP)

(73) Assignee: Panasonic Intellectual Property Management Co., Ltd., Osaka (JP)

(21) Appl. No.: 16/580,206

(22) Filed: Sep. 24, 2019

Related U.S. Application Data
(63) Continuation of application No. PCT/JP2018/004547, filed on Feb. 9, 2018.

(30) Foreign Application Priority Data
Mar. 31, 2017 (JP) 2017-070156

(51) Int. Cl. H01M 2/32; H01M 4/131; H01M 4/46; H01M 4/48; H01M 4/62

(52) U.S. Cl. CPC H01M 2/32; H01M 4/131; H01M 2004/028; H01M 4/48; H01M 4/621; H01M 4/463

(57) ABSTRACT

A positive electrode is disclosed including a positive electrode collector containing aluminum, a positive electrode mixture layer containing a positive electrode active substance constituted from a lithium transition metal oxide, and a protective layer provided between the positive electrode collector and the positive electrode mixture layer. The protective layer contains inorganic compound particles and a conductive material, and has a recessed structure wherein the positive electrode mixture layer is recessed into the protective layer.

### TECHNICAL FIELD

The present disclosure relates to a secondary battery.

### BACKGROUND ART

A non-aqueous electrolyte secondary battery, which achieves charge and discharge by movement of lithium ions between positive and negative electrodes, has a high energy density and a large capacity, and is thus used widely as a power source for driving mobile digital devices such as mobile phones, laptop computers, and smartphones, or as a power source for engines of electric tools, electric vehicles (EV), hybrid electric vehicles (HEV, PHEV), and the like, and thus wider spread use thereof is expected.

Patent Literature 1 discloses a positive electrode for a non-aqueous electrolyte secondary battery, the positive electrode comprising a protective layer between a positive electrode current collector including aluminum as a main component and a positive electrode mixture layer including a lithium transition metal oxide, the protective layer having a thickness of 1 μm to 5 μm and including: an inorganic compound having a lower oxidizing power than the lithium transition metal oxide; and a conductive agent. According to Patent Literature 1, in a case where internal short circuit of a battery occurs, in a case where a battery is exposed to a high temperature, or in other cases, there is a possibility that a large amount of heat is generated by the oxidation-reduction reaction between a positive electrode active material and an aluminum collector, but such heat generation due to the oxidation-reduction reaction can be suppressed while a satisfactory current collectability is kept by the positive electrode for a non-aqueous electrolyte secondary battery, comprising the protective layer.

### CITATION LIST

### Patent Literature

PATENT LITERATURE 1: Japanese Unexamined Patent Application Publication No. 2016-127000

### SUMMARY

In the technique described in Patent Literature 1, the protective layer having a predetermined thickness is provided between the positive electrode current collector and the positive electrode mixture layer, but bonding between the positive electrode mixture layer and the protective layer is thereby insufficient, and thus there is a concern that electronic resistance between the positive electrode active material included in the positive electrode mixture layer and the protective layer increases to deteriorate the input-output characteristics of a secondary battery.

Therefore, a secondary battery is demanded in which the heat generation due to the oxidation-reduction reaction between the positive electrode active material and the collector at the time of occurrence of abnormality, such as internal short circuit, is suppressed, and the input-output characteristics are improved.

A secondary battery that is one aspect of the present disclosure, comprises: a positive electrode: a negative electrode; and an electrolyte, wherein the positive electrode comprises: a positive electrode current collector; a positive electrode mixture layer including a positive electrode active material composed of a lithium transition metal oxide; and a protective layer provided between the positive electrode current collector and the positive electrode mixture layer, and the protective layer includes inorganic compound particles and a conductive agent, and has a recessed structure where the positive electrode mixture layer is recessed into the protective layer.

According to the secondary battery of one aspect of the present disclosure, a secondary battery may be provided in which heat generation of the battery due to the oxidation-reduction reaction between the positive electrode active material and the collector at the time of occurrence of abnormality such as internal short circuit is suppressed, and the input-output characteristics are improved.

### BRIEF DESCRIPTION OF DRAWINGS

FIG. 1 is a longitudinal sectional view schematically showing a non-aqueous electrolyte secondary battery according to one exemplary embodiment.

FIG. 2 is an SEM image of a section of a positive electrode in non-aqueous electrolyte secondary batteries of Examples.

### DESCRIPTION OF EMBODIMENTS

A secondary battery (hereinafter, also simply referred to as “battery”) that is one aspect of the present disclosure, comprises: a positive electrode; a negative electrode; and an electrolyte, wherein the positive electrode comprises: a positive electrode current collector; a positive electrode mixture layer including a positive electrode active material composed of a lithium transition metal oxide; and a protective layer provided between the positive electrode current collector and the positive electrode mixture layer, and the protective layer includes inorganic compound particles and a conductive agent, and has a recessed structure where the positive electrode mixture layer is recessed into the protective layer. The present inventors have found that even when a protective layer having a predetermined thickness is provided between a positive electrode current collector and a positive electrode mixture layer, the electronic resistance between the positive electrode active material and the protective layer can be reduced and the input-output characteristics of a battery can be improved by providing a recessed structure where the positive electrode mixture layer is recessed into the protective layer on the surface of the protective layer on the side of the positive electrode mixture layer.

Hereinafter, exemplary embodiments of the present disclosure will be described in detail with reference to the drawings. The drawings referred for the description of embodiments are schematically illustrated, and the dimension ratios and the like of the components may be different from the actual things. Specific dimension ratios and the like should be determined in consideration of the description below.

[Secondary Battery]

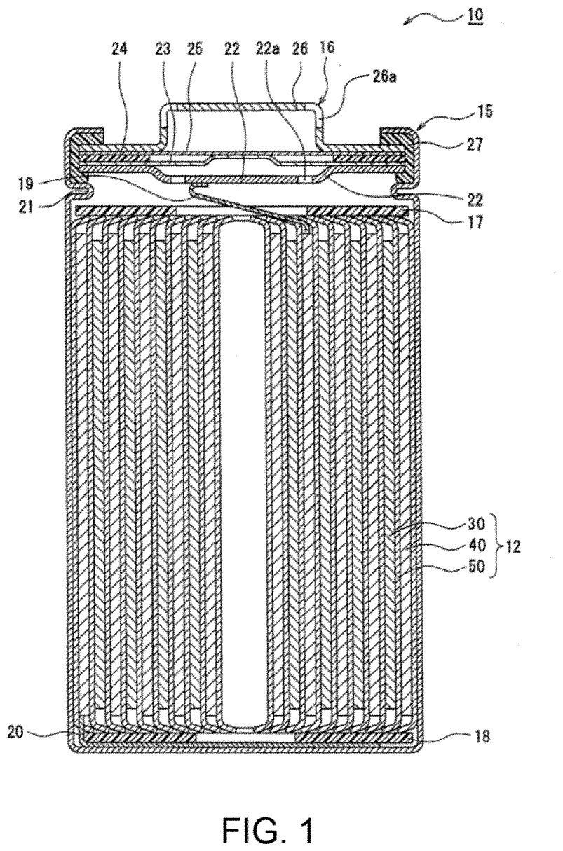

Using FIG. 1, the configuration of a secondary battery 10 will be described. FIG. 1 is a sectional view of the secondary battery 10 as one example of the embodiments. The secondary battery 10 comprises a positive electrode 30, a negative electrode 40, and an electrolyte. A separator 50 is suitably provided between the positive electrode 30 and the negative electrode 40. The secondary battery 10 has, for example, a configuration in which a wound type electrode assembly 12 in which the positive electrode 30 and the negative electrode 40 are wound together with the separator 50 therebetween and the electrolyte are housed in a battery case. Examples of the battery case for housing the electrode assembly 12 and the electrolyte include a metallic case in a shape, such as a cylindrical shape, a rectangular shape, a coin shape, and a button shape, and a resin case formed by laminating resin sheets (laminate battery). In addition, an electrode in another form, such as a lamination type electrode assembly in which positive electrodes and negative electrodes are alternately laminated with separators therebetween may be applied in place of the wound type electrode assembly 12. In the example shown in FIG. 1, the battery case includes a case main body 15 having a bottomed cylindrical shape and a sealing body 16.

The secondary battery 10 comprises insulating plates 17, 18 disposed on and under the electrode assembly 12 respectively. In the example shown in FIG. 1, a positive electrode lead 19 attached to the positive electrode 30 extends on the side of the sealing body 16 through a through-hole of the insulating plate 17, and a negative electrode lead 20 attached to the negative electrode 40 extends on the bottom side of the case main body 15 through the outside of the insulating plate 18. For example, the positive electrode lead 19 is connected by welding or the like to the underside of a filter 22 that is a bottom plate of the sealing body 16, and a cap 26 that is a top plate of the sealing body 16, the cap electrically connected to the filter 22, is a positive electrode terminal. The negative electrode lead 20 is connected by welding or the like to the inner face of the bottom part of the case main body 15, and the case main body 15 is a negative electrode terminal. In the present embodiment, a current interrupt device (CID) and a gas discharge mechanism (safety valve) are provided in the sealing body 16. A gas discharge valve (not shown) is suitably provided also at the bottom part of the case main body 15.

The case main body 15 is, for example, a metallic container having a bottomed cylindrical shape. A gasket 27 is provided between the case main body 15 and the sealing body 16 and the air tightness inside the battery case is secured. The case main body 15 suitably has an overhanging part 21 which is formed by, for example, pressing the side face part from outside and supports the sealing body 16. The overhanging part 21 is preferably formed into a ring shape along the circumferential direction of the case main body 15 and supports the sealing body 16 at the top side thereof.

The sealing body 16 has the filter 22 in which a filter opening 22a is formed and a valve body disposed on the filter 22. The valve body covers the filter opening 22a of the filter 22 and breaks if the inner pressure of the battery increases due to heat generation by internal short circuit or the like. In the present embodiment, a lower valve body 23 and an upper valve body 25 are each provided as the valve body, and an insulating member 24 disposed between the lower valve body 23 and the upper valve body 25, and the cap 26 having a cap opening 26a are further provided. Respective members included in the sealing body 16 have a disk shape or a ring shape, and respective members excluding the insulating member 24 are electrically connected to one another. Specifically, the filter 22 and the lower valve body 23 are bonded to each other at the peripheral edge parts thereof, and the upper valve body 25 and the cap 26 are also bonded to each other at the peripheral edge parts thereof. The lower valve body 23 and the upper valve body 25 are connected to each other at the central parts thereof with the insulating member 24 interposed between the peripheral edge parts thereof. If the internal pressure increases due to the heat generation by the internal short circuit or the like, for example, the lower valve body 23 breaks at the thin wall part, the upper valve body 25 thereby expands toward the side of the cap 26 and separates from the lower valve body 23, and the electrical connection between the two is thereby cut off

[Positive Electrode]

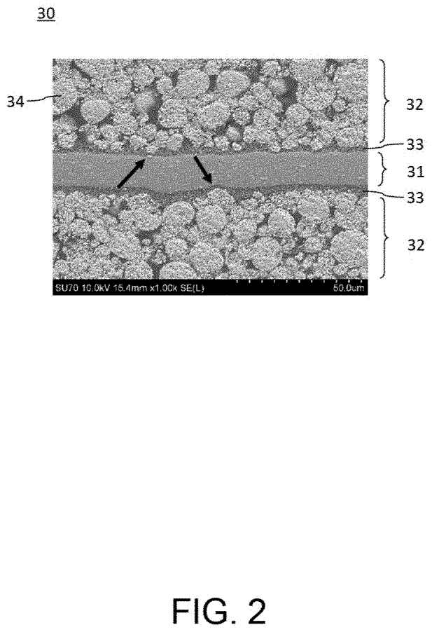

FIG. 2 shows an SEM image of a section obtained by cutting the positive electrode 30 in the thickness direction, the SEM image taken by a scanning electron microscope (SEM). The positive electrode 30 comprises: a positive electrode current collector 31; a positive electrode mixture layer 32; and a protective layer 33 provided between the positive electrode current collector 31 and the positive electrode mixture layer 32.

The positive electrode current collector 31 includes aluminum and is formed of, for example, an aluminum simple substance or metal foil composed of an aluminum alloy. The content of aluminum in the positive electrode current collector 31 is 50 mass % or more, preferably 70 mass % or more, and more preferably 80 mass % or more based on the total amount of the positive electrode current collector 31. The thickness of the positive electrode current collector 31 is not particularly limited, but is, for example, about 10 μm or more and 100 μm or less.

The positive electrode mixture layer 32 includes a positive electrode active material 34 composed of a lithium transition metal oxide. Examples of the lithium transition metal oxide include a lithium transition metal oxide containing: lithium (Li); and a transition metal element, such as cobalt (Co), manganese (Mn), and nickel (Ni). The lithium transition metal oxide may include another additive element in addition to Co, Mn, and Ni, and examples thereof include aluminum (Al), zirconium (Zr), boron (B), magnesium (Mg), scandium (Sc), yttrium (Y), titanium (Ti), iron (Fe), copper (Cu), zinc (Zn), chromium (Cr), lead (Pb), tin (Sn), sodium (Na), potassium (K), barium (Ba), strontium (Sr), calcium (Ca), tungsten (W), molybdenum (Mo), niobium (Nb), and silicon (Si).

Specific examples of the lithium transition metal oxide include LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LixMn_{2-y}M_{y}O₄, LiMPO₄, and Li₂MPO₄F (in each chemical formula, M represents at least one of Na, Mg, Sc, Y, Mn, Fe, Co, Ni, Cu, Zn, Al, Cr, Pb, Sb, and B, 0<x≤1.2, 0<y≤0.9, and 2.0≤z≤2.3). These may be used singly or in combinations of two or more thereof.

Among others, the lithium nickel composite oxide represented by LiₓNi_{1-y}M_{y}Oₓ (in the formula, M represents at least one of Na, Mg, Sc, Y, Mn, Fe, Co, Cu, Zn, Cr, Pb, Sb, and B, 0<x≤1.2, 0<y≤0.9, and 2.0≤z≤2.3) is preferably used. The lithium nickel composite oxide preferably contains at least one of Co, Mn, and Al, and more preferably contains Co and Al in addition to Li and Ni.

The content of the positive electrode active material 34 in the positive electrode mixture layer 32 is preferably 90 mass % or more, and more preferably 95 mass % or more based on the total amount of the positive electrode mixture layer 32. The average particle diameter (central particle diameter measured by light scattering method) of the positive electrode active material 34 is, for example, 5 μm or more and 20 μm or less, and, from the viewpoint of forming the recessed structure where the positive electrode mixture layer 32 is recessed into the protective layer 33, preferably 7 μm or more and 15 μm or less.

The positive electrode mixture layer 32 suitably further includes a conductive agent and a binder. The conductive agent included in the positive electrode mixture layer 32 is used for enhancing the electrical conductivity of the positive electrode mixture layer 32. Examples of the conductive agent include carbon materials such as carbon black (CB), acetylene black (AB), Ketjenblack, and graphite. These may be used singly or in combinations of two or more thereof. The content of the conductive agent in the positive electrode mixture layer 32 is preferably 0.1 mass % or more and 10 mass % or less, and more preferably 0.5 mass % or more and 5 mass % or less based on the total amount of the positive electrode mixture layer 32.

The binder included in the positive electrode mixture layer 32 is used for keeping a satisfactory state of contact between the positive electrode active material 34 and the conductive agent and enhancing the binding performance of the positive electrode active material 34 and the like to the surface of the positive electrode current collector 31. Examples of the binder include fluororesins such as polytetrafluoroethylene (PTFE) and poly(vinylidene fluoride) (PVdF), polyacrylonitrile (PAN), polyimide resins, acrylic resins, and polyolefin resins. These resins may be combined with carboxymethyl cellulose (CMC) or a salt thereof (such as CMC-Na, CMC-K, and CMC-NH₄, or may be a partially neutralized salt), polyethylene oxide (PEO), or the like. These may be used singly or in combinations of two or more thereof. The content of the binder in the positive electrode mixture layer 32 is preferably 0.1 mass % or more and 10 mass % or less, and more preferably 0.5 mass % or more and 5 mass % or less based on the total amount of the positive electrode mixture layer 32.

In the battery 10 according to the present embodiment, for example, the density of the positive electrode active material 34 in the positive electrode mixture layer 32 is preferably 3.3 g/cm³ or more, and more preferably 3.5 g/cm³ or more. This is because when the density of the positive electrode active material 34 in the positive electrode mixture layer 32 is in the range, the capacity density of the battery 10 is thereby still more improved. The density of the positive electrode active material 34 in the positive electrode mixture layer 32 can be calculated, for example, as follows: a section of the positive electrode 30 in the thickness direction is observed with a scanning electron microscope (SEM) to determine the grain boundaries of the positive electrode active material particles included in a predetermined range of an SEM image and draw a visible outline along the surface of each particle; and the density can be calculated based on a ratio of the area of the predetermined range to the total area of the parts each surrounded by the visible outline, and the true density of the positive electrode active material 34.

The protective layer 33 is provided between the positive electrode current collector 31 and the positive electrode mixture layer 32 in the positive electrode 30 and includes the inorganic compound particles (hereinafter, also simply referred to as “inorganic particles”) and the conductive agent. The protective layer 33 includes the inorganic particles and is provided between the positive electrode current collector 31 and the positive electrode mixture layer 32, thereby serving a function of isolating the positive electrode current collector 31 and the positive electrode mixture layer 32 to suppress the oxidation-reduction reaction between aluminum included in the positive electrode current collector 31 and the lithium transition metal oxide included as the positive electrode active material 34 in the positive electrode mixture layer 32.

In the battery 10 according to the present embodiment, the protective layer 33 has a recessed structure where the positive electrode mixture layer 32 is recessed into the protective layer 33. The recessed structure where the positive electrode mixture layer 32 is recessed into the protective layer 33 refers to a structure where depressions (depressed portions) are formed at the interface of the protective layer 33 where the protective layer 33 is in contact with the positive electrode mixture layer 32 and a material (e.g. positive electrode active material 34) included in the positive electrode mixture layer 32 gets into the depressed portions. In other words, the recessed structure refers to a structure in which unevenness is formed at the interface between the protective layer 33 and the positive electrode mixture layer 32 when the material such as the positive electrode active material 34 protruding from the surface of the positive electrode mixture layer 32 is pressed against the protective layer 33. In FIG. 2, portions where the recessed structure is formed in the protective layer 33 are shown by arrows. When the protective layer 33 has such a recessed structure in the battery 10 according to the present embodiment, the contact area between the positive electrode active material 34 included in the positive electrode mixture layer 32 and the protective layer 33 increases, so that the electronic resistance between the positive electrode active material 34 and the protective layer 33 can be reduced, and as a result, the input-output characteristics of the secondary battery 10 can be improved.

The extent of the uneven shape which is formed on the surface of the protective layer 33 on the side of the positive electrode mixture layer 32 and is based on the recessed structure formed by the positive electrode mixture layer 32 can be decided by, for example, the standard deviation 6 of the thickness distribution of the protective layer 33. In the battery 10 according to the present embodiment, the standard deviation 6 of the thickness distribution of the protective layer 33 is preferably 0.5 μm or more, and more preferably 1.0 μm or more. In addition, the standard deviation 6 of the thickness distribution of the protective layer 33 is preferably 30% or more and 50% or less based on the average thickness of the protective layer 33. This is because when the standard deviation 6 of the thickness distribution of the protective layer 33 is in the range, the contact area between the protective layer 33 and the positive electrode active material 34 included in the positive electrode mixture layer 32 increases to reduce the electronic resistance between the positive electrode active material 34 and the protective layer 33, so that the input-output characteristics of the secondary battery 10 can be improved. The upper limit of the standard deviation 6 of the thickness distribution of the protective layer 33 is not particularly limited, but is, for example, 3.0 μm or less.

From the viewpoint of improving the capacity density, the protective layer 33 has an average thickness of 4 μm or less, and more preferably 3 μm or less. The lower limit of the average thickness of the protective layer 33 is not particularly limited, but is, for example, 0.5 μm or more, and preferably 1 μm or more. This is because if the protective layer 33 is too thin, there is a possibility that the effect of suppressing the oxidation-reduction reaction at the time of occurrence of abnormality is not obtained sufficiently.

Examples of the method of measuring the average thickness and thickness distribution of the protective layer 33 include the following method. The battery 10 is first disassembled to take out the electrode assembly 12, and, further, the electrode assembly is separated into the positive electrode 30, the negative electrode 40, and the separator 50. After the obtained positive electrode 30 is embedded in a resin and cut along the thickness direction, the surface is polished. The polished surface is observed with a scanning electron microscope (SEM). In the obtained SEM image, two visible outlines consisting of a line along the surface of the protective layer 33 on the side of the positive electrode mixture layer 32 and a line along the surface of the protective layer 33 on the side of the positive electrode current collector 31 are drawn. The thickness of the protective layer 33 is measured at 50 positions randomly selected. The average thickness of the protective layer 33 and the standard deviation 6 of the thickness as an index of the thickness distribution are calculated from the 50 measured values.

It can be considered that in the battery 10 according to the present embodiment, a region where the protective layer 33 does not exist locally and the positive electrode current collector 31 and the positive electrode mixture layer 32 are in direct contact with each other exists in the region, depending on the average thickness and thickness distribution of the protective layer 33. The protective layer 33 may include the region where the positive electrode current collector 31 and the positive electrode mixture layer 32 are in direct contact with each other as long as the protective layer 33 as a whole keeps the effect of suppressing the oxidation-reduction reaction between the positive electrode current collector 31 and the positive electrode mixture layer 32. The proportion of the positive electrode mixture layer 32 can be increased by an amount corresponding to the proportion of the protective layer 33 reduced in the positive electrode 30 as a result of thinning the protective layer 33, so that the battery capacity can be improved.

The average thickness and thickness distribution of the protective layer 33 may be selected appropriately in view of the suppression of the oxidation-reduction reaction between the positive electrode current collector 31 and the positive electrode mixture layer 32, and the balance between the capacity density and the input-output characteristics, but from the viewpoint of keeping the effect of suppressing the oxidation-reduction reaction between the positive electrode current collector 31 and the positive electrode mixture layer 32, the area of regions where the thickness of the protective layer 33 is 0.5 μm or less is preferably 20% or less based on the total area of the protective layer 33, and a value obtained by dividing the standard deviation 6 of the thickness distribution of the protective layer 33 by the average thickness is preferably 50% or less.

The positive electrode mixture layer 32 is provided by forming a coating film of a positive electrode mixture slurry on the surface of the protective layer 33, drying the coating film, and then rolling the resulting product. It can be considered that the recessed structure which the protective layer 33 according to the present embodiment has is mainly formed when the material, such as the positive electrode active material 34, protruding from the surface of the positive electrode mixture layer 32 is pressed against the protective layer 33 in the rolling step of rolling this coating film after drying. The size of the recessed structure which the protective layer 33 according to the present embodiment has can be adjusted by, for example, adjusting the density of the positive electrode active material 34 in the positive electrode mixture layer 32, the porosity of the protective layer 33, and the like. The larger the density of the positive electrode active material 34 in the positive electrode mixture layer 32 is, the deeper the unevenness of the recessed structure in the protective layer 33 is (that is, the larger the standard deviation 6 of the thickness of the protective layer 33 is). There is a tendency that the higher the porosity of the protective layer 33 is, the deeper the unevenness of the recessed structure is, because the positive electrode active material 34 and the like penetrate deeper into the protective layer 33.

The protective layer 33 preferably has a porosity of, for example, 30% or more and 60% or less. If the porosity is too small, the recessed structure formed in the protective layer 33 is shallow, so that the effects of improving the capacity density and input-output characteristics may be deficient. If the porosity is too large, the electrical conductivity in the protective layer 33 may be deteriorated. The porosity of the protective layer 33 can be calculated, for example, as follows: a predetermined range in an SEM image of a section of the protective layer 33 in the thickness direction is observed to determine the grain boundaries of the particles, such as the inorganic particles, the conductive agent, and the binder, which are included in the protective layer 33, and draw a visible outline along the surface of each particle; and the porosity can be calculated based on the area of the predetermined range and the total area of the parts each surrounded by the visible outline.

Examples of a method of adjusting the porosity of the protective layer 33 include a method, which will be described later, of using inorganic particles having a shape formed by connecting a plurality of primary particles, and a method of adjusting the porosity by the type, the content, and the like of the binder to be used for the protective layer 33.

The inorganic particles included in the protective layer 33 are particles composed of an inorganic compound. The inorganic compound composing the inorganic particles is not particularly limited, but preferably has a lower oxidizing power than the lithium transition metal oxide included in the positive electrode mixture layer 32 from the viewpoint of suppressing the oxidation-reduction reaction. Examples of the inorganic compounds include inorganic oxides such as manganese oxide, silicon dioxide, titanium dioxide, and aluminum oxide. As the inorganic compound, aluminum oxide (Al₂O₃) is preferable because of having a high chemical stability and being inexpensive, and more preferably α-alumina, which has a crystal structure of the trigonal system.

As the inorganic particles, inorganic particles having a shape formed by connecting a plurality of primary particles is preferably used for the protective layer 33. This is because the particles (hereinafter, also referred to as “connected particles”) having such a shape have a low bulk density to make it easy to adjust the porosity of the protective layer 33. Examples of the connected particles include particles in which a plurality of primary particles are connected by melt, and particles in which a plurality of particles during crystal growth contact to be integrated in the middle of the crystal growth. The connected particles may be composed of, for example, about 2 to about 10 primary particles.

The method for obtaining the connected particles is not particularly limited, and examples thereof include a method of sintering inorganic particles into a lump material and pulverizing the lump material moderately, or a method of contacting particles during crystal growth with one another. For example, when the connected particles are obtained by sintering α-alumina particles, the sintering temperature is preferably 800° C. or more and 1300° C. or less, and the sintering time is preferably 3 minutes or more and 30 minutes or less. Pulverization of the lump material can be carried out using wet equipment such as a ball mill, or dry equipment such as a jet mill, and by adjusting the pulverization conditions appropriately, the particle diameter of the connected particles can be controlled.

The inorganic particles have an average particle diameter (central particle diameter measured by light scattering method) of, for example, 1 μm or less, and preferably 0.01 μm or more and 1 μm or less. If the particle diameter of the inorganic particles is too large, the porosity of the protective layer 33 is made large, so that there is a possibility that the electrical conductivity of the protective layer 33 is deteriorated. On the other hand, if the particle diameter of the inorganic particles is too small, the porosity of the protective layer 33 is made small and the protective layer 33 is formed densely, and thus there is a possibility that it is made difficult to allow the positive electrode active material particles in the positive electrode mixture layer 32 to be recessed into the protective layer 33.

The content of the inorganic particles included in the protective layer 33 is preferably 70 mass % or more and 99.8 mass % or less, and more preferably 90 mass % or more and 99 mass % or less based on the total amount of the protective layer 33. When the content of the inorganic particles is within the range, an effect of suppressing the oxidation-reduction reaction is improved to make it easy to reduce the amount of heat to be generated at the time of occurrence of abnormality.

The conductive agent included in the protective layer 33 is used for securing a satisfactory current collectability of the positive electrode 30. The conductive agent may be, for example, the same type of the conductive agent to be used in the positive electrode mixture layer 32, and specific examples thereof include, but not limited to, carbon materials such as carbon black (CB), acetylene black (AB), Ketjenblack, and graphite. These may be used singly or in combinations of two or more thereof.

The content of the conductive agent included in the protective layer 33 is preferably 0.1 mass % or more and 20 mass % or less, and more preferably 1 mass % or more and 10 mass % or less based on the total amount of the protective layer 33. From the viewpoint of securing the current collectability, the content of the conductive agent in the protective layer 33 is preferably higher than the content of the conductive agent in the positive electrode mixture layer 32.

The protective layer 33 preferably includes a binder. This is because when the protective layer 33 includes a binder, the binder binds the inorganic particles and the conductive agent to secure the mechanical strength of the protective layer 33 and enhances the binding performance between the protective layer 33 and the positive electrode current collector 31. The binder included in the protective layer 33 may be, for example, the same type of the binder to be used in the positive electrode mixture layer 32, and specific examples thereof include, but not limited to, fluororesins such as PTFE and PVdF, PAN, polyimide resins, acrylic resins, and polyolefin resins. These may be used singly or in combinations of two or more of thereof. The content of the binder is preferably 0.1 mass % or more and 20 mass % or less, and more preferably 1 mass % or more and 10 mass % or less based on the total amount of the protective layer 33.

The positive electrode 30 according to the present embodiment can be produced by, for example, the following method. The protective layer 33 is first provided on the surface of the positive electrode current collector 31. The protective layer 33 can be formed by, for example, applying a protective layer slurry obtained by mixing the inorganic particles, the conductive agent, and the binder with a dispersion medium such as N-methyl-2-pyrrolidone (NMP) to the surface of the positive electrode current collector 31 and drying the resulting applying layer. When the positive electrode mixture layer 32 is provided on each side of the positive electrode current collector 31, the protective layer 33 is also provided on each side of the positive electrode current collector 31.

Subsequently, the positive electrode mixture layer 32 is provided so as to overlay the protective layer 33 which has been provided on the surface of the positive electrode current collector 31. The positive electrode mixture layer 32 can be formed by, for example, applying a positive electrode mixture slurry obtained by mixing the positive electrode active material 34, the conductive agent, and the binder with a dispersion medium such as N-methyl-2-pyrrolidone (NMP) to a side of the positive electrode current collector 31, the side having the protective layer 33 formed thereon, drying the resulting applying layer, and rolling the resulting product using rolling means such as a rolling mill. Thereby, the positive electrode 30 having the protective layer 33 and the positive electrode mixture layer 32 formed in sequence on the surface of the positive electrode current collector 31 can be produced. Means for applying the positive electrode mixture slurry to the positive electrode current collector 31 is not particularly limited, and a well-known apparatus, such as a gravure coater, a slit coater, and a die coater, may be used.

[Negative Electrode]

The negative electrode 40 includes, for example, a negative electrode current collector formed of metal foil or the like and a negative electrode mixture layer formed on the surface of the collector. Foil of a metal, such as copper, that is stable in the electric potential range of the negative electrode, a film with such a metal disposed on an outer layer, and the like can be used for the negative electrode current collector. The negative electrode mixture layer suitably includes a binder in addition to a negative electrode active material. The negative electrode 40 can be manufactured by, for example, applying a negative electrode mixture slurry including the negative electrode active material, the binder, and other components to the negative electrode current collector, drying the resulting applying layer, and rolling the resulting product to form a negative electrode mixture layer on each side of the collector.

The negative electrode active material is not particularly limited as long as it is a compound that can reversibly intercalate and deintercalate lithium ions, and, for example, a carbon material, such as natural graphite and artificial graphite, a metal, such as silicon (Si) and tin (Sn), that can be alloyed with lithium, an alloy or composite oxide including a metal element, such as Si and Sn, or the like can be used. The negative electrode active materials can be used singly or in combinations of two or more thereof.

As the binder included the negative electrode mixture layer, similarly to the case of the positive electrode 30, a fluorocarbon resin such as PTFE, PAN, a polyimide resin, an acrylic resin, a polyolefin resin, or the like can be used. When the negative electrode mixture slurry is prepared using an aqueous solvent, styrene-butadiene rubber (SBR), CMC or its salt, poly(acrylic acid) (PAA) or its salt (such as PAA-Na and PAA-K, or may be a partially neutralized salt), poly(vinyl alcohol) (PVA), or the like is preferably used.

[Separator]

An ion-permeable and insulating porous sheet is used as the separator 50. Specific examples of the porous sheet include a microporous thin film, woven fabric, and nonwoven fabric. Suitable examples of the material for the separator 50 include olefin resins such as polyethylene and polypropylene, and cellulose. The separator 50 may be a laminate including a cellulose fiber layer and a layer of fibers of a thermoplastic resin such as an olefin resin. The separator 50 may be a multi-layered separator including a polyethylene layer and a polypropylene layer, and the separator 50 a surface of which is coated with a resin such as an aramid resin may also be used.

A filler layer including a filler of an inorganic substance may be formed on an interface between the separator 50 and at least one of the positive electrode 30 and the negative electrode 40. Examples of the filler of an inorganic substance include an oxide containing at least one of titanium (Ti), aluminum (Al), silicon (Si), and magnesium (Mg) and a phosphoric acid compound. The filler layer can be formed by, for example, applying a slurry containing the filler to the surface of the positive electrode 30, the negative electrode 40, or the separator 50.

[Electrolyte]

The electrolyte includes a solvent and an electrolyte salt dissolved in the solvent. As the solvent, for example, a non-aqueous solvent such as an ester, an ether, a nitrile such as acetonitrile, an amide such as dimethylformamide, and a mixed solvent of two or more of these solvents can be used. The non-aqueous solvent may contain a halogen-substituted product formed by replacing at least one hydrogen atom of any of the above solvents with a halogen atom such as fluorine. As the electrolyte, a solid electrolyte using a gel polymer or the like may be used.

Examples of the ester include cyclic carbonate esters such as ethylene carbonate (EC), propylene carbonate (PC), and butylene carbonate; chain carbonate esters such as dimethyl carbonate (DMC), methyl ethyl carbonate (EMC), diethyl carbonate (DEC), methyl propyl carbonate, ethyl propyl carbonate, and methyl isopropyl carbonate; cyclic carboxylate esters such as γ-butyrolactone and γ-valerolactone; and chain carboxylate esters such as methyl acetate, ethyl acetate, propyl acetate, methyl propionate (MP), ethyl propionate, and γ-butyrolactone.

Examples of the ether include cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and crown ethers; and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

As the halogen-substituted product, a fluorinated cyclic carbonate ester such as fluoroethylene carbonate (FEC), a fluorinated chain carbonate ester, or a fluorinated chain carboxylate ester such as methyl fluoropropionate (FMP) is preferably used.

The electrolyte salt is preferably a lithium salt. Examples of the lithium salt include LiBF₄, LiClO₄, LiPF₆, LiAsF₆, LiSbF₆, LiAlCl₄, LiSCN, LiCF₃SO₃, LiCF₃CO₂, Li(P(C₂O₄)F₄), Li(P(C₂O₄)F₂), LiPF₆₋ₓ(CₙF₂ₙ₊₁)ₓ (where 1<x<6, and n is 1 or 2), LiB₁₀Cl₁₀, LiCl, LiBr, LiI, chloroborane lithium, lithium short-chain aliphatic carboxylates, borate salts such as Li₂B₄O₇ and Li(B(C₂O₄)F₂), and imide salts such as LiN(SO₂CF₃)₂ and LiN(CₗF₂ₗ₊₁SO₂)(CₘF₂ₘ₊₁SO₂) {where l and m are integers of 1 or more}. As the lithium salt, these may be used singly or in combinations of two or more thereof. Among these, LiPF₆ is preferably used from the viewpoint of ionic conductivity, electrochemical stability, and the like. The concentration of the lithium salt is preferably set to 0.8 to 1.8 mol per 1 L of a solvent.

### EXAMPLES

Hereinafter, the present disclosure will be described in more detail with Examples, but the present disclosure is not limited to these Examples.

### Example 1

[Production of Positive Electrode]

A protective layer slurry was prepared by mixing 92 parts by mass of inorganic particles (central particle diameter of 0.7 μm) composed of α-alumina and having a shape formed by connecting a plurality of primary particles, 5 parts by mass of acetylene black (AB), and 3 parts by mass of poly (vinylidene fluoride) (PVdF), and, further, adding an appropriate amount of N-methyl-2-pyrrolidone (NMP). Next, the protective layer slurry was applied on each side of a positive electrode current collector 31 formed of aluminum foil having a thickness of 15 and the applied slurry was dried to form a protective layer 33.

A positive electrode mixture slurry was prepared by mixing 100 parts by mass of a lithium nickel composite oxide represented by LiNi_{0.82}CO_{0.15}Al_{0.03}O₂ as a positive electrode active material 34, 1.0 part by mass of acetylene black (AB), and 0.8 parts by mass of poly(vinylidene fluoride) (PVdF), and further, adding an appropriate amount of N-methyl-2-pyrrolidone (NMP). Next, the positive electrode mixture slurry was applied on each side of the positive electrode current collector 31 having the protective layer 33 formed on each side thereof, and the applied slurry was dried. The resulting product was cut into a predetermined electrode size and then rolled so as to have an active material density of 3.65 g/cm³. Thereby, a positive electrode 30 having the protective layer 33 and the positive electrode mixture layer 32 formed in sequence on each side of the positive electrode current collector 31 was prepared. The central particle diameter of the positive electrode active material 34 was 11 μm.

FIG. 2 shows an SEM image of a section of the positive electrode 30 of Example 1 in the thickness direction, the section subjected to cross section processing by embedding in resin. From the SEM image shown in FIG. 2, it was ascertained that in the positive electrode 30 of Example 1, unevenness exists on the surface of the positive protective layer 33 on the side of the positive electrode mixture layer 32 and a recessed structure where the positive electrode mixture layer 32 is recessed into the protective layer 33 is formed. In addition, as a result of image processing, it was found that in the positive electrode 30 of Example 1, the average thickness of the protective layer 33 was 2.5 μm, the standard deviation of the thickness of the protective layer 33 was 1.1 and the porosity of the protective layer 33 was 37%.

[Production of Negative Electrode]

A negative electrode mixture slurry was prepared by mixing 100 parts by mass of a graphite powder, 1 part by mass of carboxymethyl cellulose (CMC), and 1 part by mass of styrene-butadiene rubber (SBR), and further, adding an appropriate amount of water. Next, the negative electrode mixture slurry was applied on each side of the negative electrode current collector formed of copper foil, and the applied slurry was dried. The resulting product was cut into a predetermined electrode size and then rolled using a roller to produce a negative electrode 40 having a negative electrode mixture layer formed on each side of the negative electrode current collector.

[Production of Electrolyte]

Ethylene carbonate (EC), methyl ethyl carbonate (EMC), and dimethyl carbonate (DMC) were mixed in a volume ratio of 1:1:8. LiPF₆ was dissolved in the mixed solvent at a concentration of 1.2 mol/L to produce a non-aqueous electrolyte.

[Production of Battery]

Produced positive electrode plate and negative electrode plate were spirally wound through a separator to thereby produce a wound type electrode assembly. As the separator, a 16-μm microporous polyethylene film was used. The electrode assembly was housed in a battery case main body having a bottomed cylindrical shape, the battery case main body having an outer diameter of 18 mm and a height of 65 mm, and after the non-aqueous electrolyte was injected thereinto, the opening of the battery case main body was sealed by a gasket and a sealing body, to thereby produce a cylindrically shaped non-aqueous electrolyte secondary battery of a 18650 type. The rated capacity was set to 3200 mAh.

### Example 2

A battery 10 was produced in the same manner as in Example 1, except that rolling was carried out using a rolling mill so that the active material density would be 3.45 g/cm³ in the step of producing the positive electrode 30. From an SEM image of a section of the positive electrode 30 of Example 2 in the thickness direction, the section subjected to cross section processing by embedding in resin, it was ascertained that unevenness exists on the surface of the protective layer 33 on the side of the positive electrode mixture layer 32 and a recessed structure where the positive electrode mixture layer 32 is recessed into the protective layer 33 is formed. In addition, as a result of image processing, it was found that in the positive electrode 30 of Example 2, the average thickness of the protective layer 33 was 3.0 μm, the standard deviation 6 of the thickness of the protective layer 33 was 1.4 μm, and the porosity of the protective layer 33 was 43%.

### Example 3

A battery 10 was produced in the same manner as in Example 1, except that rolling was carried out using a rolling mill so that the active material density would be 3.3 g/cm³ in the step of producing the positive electrode 30. From an SEM image of a section of the positive electrode 30 of Example 3 in the thickness direction, the section subjected to cross section processing by embedding in resin, it was ascertained that unevenness exists on the surface of the protective layer 33 on the side of the positive electrode mixture layer 32 and a recessed structure where the positive electrode mixture layer 32 is recessed into the protective layer 33 is formed. In addition, as a result of image processing, it was found that the average thickness of the protective layer 33 was 3.4 μm, the standard deviation of the thickness of the protective layer 33 was 1.2 and the porosity of the protective layer 33 was 48%.

### Comparative Example 1

A non-aqueous electrolyte secondary battery was produced in the same manner as in Example 1, except that rolling was carried out using a rolling mill so that the active material density would be 3.1 g/cm³ in the step of producing the positive electrode 30. In an SEM image of a section of the positive electrode of Comparative Example 1 in the thickness direction, the section subjected to cross section processing by embedding in resin, remarkable unevenness did not exist on the surface of the protective layer on the side of the positive electrode mixture layer and a recessed structure where the positive electrode mixture layer is recessed into the protective layer was not ascertained. As a result of image processing, it was found that in the positive electrode of Comparative Example 1, the average thickness of the protective layer was 4.0 μm, the standard deviation of the thickness of the protective layer was 0.4 and the porosity of the protective layer was 65%.

### Reference Example 1

A non-aqueous electrolyte secondary battery was produced in the same manner as in Example 1, except that the protective layer 33 was not provided, and rolling was carried out using a rolling mill so that the active material density would be 3.65 g/cm³.

[Measurement of Battery Capacity]

The non-aqueous electrolyte secondary batteries of the Examples, Comparative Example 1, and Reference Example 1 were charged at a constant current of 1600 mA to a battery voltage of 4.2 V and subsequently charged at a constant voltage to a current of 160 mA at 25° C. After that, discharging was carried out at a constant current of 640 mA to a battery voltage of 2.5 V. The discharge capacity at that time was defined as the initial capacity per non-aqueous electrolyte secondary battery.

[Measurement of Discharge Output Characteristic]

Charging was carried out for each non-aqueous electrolyte secondary battery of the Examples, Comparative Example 1, and Reference Example 1 at room temperature (25° C.) under the same conditions as in the measurement of the battery capacity, and the discharge capacity at the time when discharging was then carried out at a current of 3200 mA to 2.5 V was measured.

[Nail Penetration Test]

A nail penetration test was carried out according to the following procedure for each non-aqueous electrolyte secondary battery described above to measure the heat generation temperature at the time of internal short circuit.

(1) In an environment of 25° C., charging was carried out at a constant current of 1600 mA to a battery voltage of 4.2 V, and discharging was subsequently carried out at a constant voltage to a current of 160 mA.
(2) Each battery after being charged was housed in a temperature chamber of an environment of 25° C., an iron nail (diameter of 2.4 mm) was stuck into the battery at a rate of 1 mm/s, and sticking the round nail was stopped immediately after a voltage drop of the battery due to internal short circuit was detected.
(3) The surface temperature of the battery 1 minute after the short circuit of the battery was caused by the round nail was measured.

Table 1 shows the measurement results of the battery capacity, the discharge output characteristic, and the nail penetration test in each non-aqueous electrolyte secondary battery of the Examples, Comparative Example 1, and Reference Example 1. With respect to the discharge output characteristic, a ratio of the measured value of each non-aqueous electrolyte secondary battery to the measured value of the non-aqueous electrolyte secondary battery of Comparative Example 1 which is assumed to be 100 is shown.

TABLE 1

| | Protective layer | | Positive | | Discharge | Surface |
|---|---|---|---|---|---|---|
| | Average | Standard | electrode active | Battery | Output | temperature |
| | thickness | deviation σ of | material density | capacity | Characteristic | of battery |
| | [μm] | thickness [μm] | [g/cm³] | [mAh] | Ratio | [° C.] |
| Example 1 | 2.5 | 1.1 | 3.65 | 3195 | 149 | 33 |
| Example 2 | 3.0 | 1.4 | 3.45 | 3135 | 143 | 33 |
| Example 3 | 3.4 | 1.2 | 3.3 | 3076 | 138 | 33 |
| Comparative | 4.0 | 0.4 | 3.1 | 2958 | 100 | 45 |
| Example 1 | | | | | | |
| Reference | — | — | 3.65 | 3250 | 155 | 115 |
| Example 1 | | | | | | |

As can be seen from the results shown in Table 1, according to the batteries 10 of the Examples each having the protective layer 33 provided between the positive electrode current collector 31 and the positive electrode mixture layer 32, the protective layer 33 including the inorganic particles and the conductive agent and having the recessed structure where the positive electrode mixture layer 32 is recessed into the protective layer 33, the heat generation at the time of occurrence of abnormality, such as the internal short circuit due to the nail penetration, can be suppressed, and the discharge output characteristic of the battery 10 can be improved. It can be considered that this result is obtained because the protective layer 33 has the recessed structure, and thereby the contact area between the positive electrode active material 34 included in the positive electrode mixture layer 32 and the protective layer 33 increases, so that the electronic resistance between the positive electrode active material 34 and the protective layer 33 is reduced.

### REFERENCE SIGNS LIST

10 secondary battery (battery)
12 electrode assembly
15 case main body
16 sealing body
17, 18 insulating plate
19 positive electrode lead
20 negative electrode lead
21 overhanging part
22 filter
22a filter opening
23 lower valve body
24 insulating member
25 upper valve body
26 cap
26a cap opening
27 gasket
30 positive electrode
31 positive electrode current collector
32 positive electrode mixture layer
33 protective layer
34 positive electrode active material
40 negative electrode
50 separator

1. A secondary battery comprising:
a positive electrode;
a negative electrode; and
an electrolyte, wherein
the positive electrode includes:
a positive electrode current collector;
a positive electrode mixture layer including a positive electrode active material containing a lithium transition metal oxide; and
a protective layer provided between the positive electrode current collector and the positive electrode mixture layer,
the protective layer includes inorganic compound particles, a conductive agent, and a binder, and has a recessed structure where the positive electrode mixture layer is recessed into the protective layer, and
a content of the binder is 1 mass % or more and 10 mass % or less based on the total amount of the protective layer.

2. The secondary battery according to claim 1, wherein a density of the positive electrode active material in the positive electrode mixture layer is 3.2 g/cm³ or more.

3. The secondary battery according to claim 1, wherein a standard deviation 6 of a thickness distribution of the protective layer is 1.0 μm or more.

4. The secondary battery according to claim 1, wherein a standard deviation 6 of a thickness distribution of the protective layer is 30% or more and 50% or less based on an average thickness of the protective layer.

5. The secondary battery according to claim 1, wherein the protective layer has an average thickness of 3.5 μm or less.

6. The secondary battery according to claim 1, wherein the inorganic compound particles have a shape formed by connecting a plurality of primary particles.

7. The secondary battery according to claim 1, wherein the positive electrode includes a region where the protective layer does not exist locally, and
the positive electrode current collector and the positive electrode mixture layer are in direct contact with each other in the region.

8. The secondary battery according to claim 1, wherein the inorganic compound particles are particles composed of α-alumina.

9. The secondary battery according to claim 1, wherein the positive electrode active material is a lithium nickel composite oxide.
